(19) United States
(12) Patent Application Publication
(10) Pub. No.: US 2014/0166001 A1
(43) Pub. Date: Jun. 19, 2014

(54) POWERED AIR-PURIFYING RESPIRATOR HELMET WITH PHOTOVOLTAIC POWER SOURCE

(71) Applicant: LINCOLN GLOBAL, INC., City of Industry, CA (US)

(72) Inventor: Todd Kooken, Solon, OH (US)

(73) Assignee: LINCOLN GLOBAL, INC., City of Industry, CA (US)

(21) Appl. No.: 13/795,363

(22) Filed: Mar. 12, 2013

Related U.S. Application Data
(60) Provisional application No. 61/736,767, filed on Dec. 13, 2012.

(51) Int. Cl. A62B 7/10; A62B 18/08; A62B 9/00; A62B 18/04; A62B 23/02

(52) U.S. Cl. CPC A62B 7/10; A62B 18/04; A62B 23/02; A62B 9/006; A62B 18/082
USPC 128/201.25

(57) ABSTRACT

A powered air-purifying respirator helmet system includes a helmet having a lens. A photovoltaic power source is mounted on the helmet. A trunk-worn blower is separate from the helmet. The trunk-worn blower includes a fan and a rechargeable battery operably connected to power the fan. A flexible air-electrical conductor interconnects the trunk-worn blower and the helmet to simultaneously supply both pressurizing air to the helmet and electrical energy generated by the photovoltaic power source on the helmet to the trunk-worn blower.

### CROSS-REFERENCE TO RELATED APPLICATIONS

Benefit of U.S. Provisional Patent Application Ser. No. 61/736,767 filed Dec. 13, 2012, is hereby claimed and the disclosure incorporated herein by reference.

### BACKGROUND OF THE INVENTION

1. Field of the Invention

The present invention relates to welding helmets, and in particular to powered air-purifying respirator (PAPR) welding helmets.

2. Description of Related Art

PAPR welding helmets are supplied with a flow of air from a blower to create a positive air pressure within the helmet. The positive air pressure helps keep environmental contaminants, such as welding fumes, out of the helmet, so that they are not inhaled by the welding operator. The blower of the PAPR system is typically worn on the body of the welding operator, such as on a belt. An air hose connects the blower to the PAPR helmet. The blower can include one or more air filters for cleaning the air drawn from the welding environment. The blower can be battery-powered. However, batteries are heavy, and the use of a PAPR system during welding can fatigue the welding operator. Further, the battery can become discharged during use, temporarily rendering the PAPR system unusable while the battery is recharged or necessitating the replacement of the battery with a spare.

### BRIEF SUMMARY OF THE INVENTION

The following summary presents a simplified summary in order to provide a basic understanding of some aspects of the devices and systems discussed herein. This summary is not an extensive overview of the devices and systems discussed herein. It is not intended to identify critical elements or to delineate the scope of such devices and systems. Its sole purpose is to present some concepts in a simplified form as a prelude to the more detailed description that is presented later.

Example aspects and embodiments of the present invention are summarized below. It is to be appreciated that the example aspects and/or embodiments may be provided separately or in combination with one another.

In accordance with one aspect of the present invention, provided is a powered air-purifying respirator helmet system. The system includes a helmet having a lens. A photovoltaic power source is mounted on the helmet. A trunk-worn blower is separate from the helmet. The trunk-worn blower includes a fan and a rechargeable battery operably connected to power the fan. A flexible air-electrical conductor interconnects the trunk-worn blower and the helmet to simultaneously supply both pressurizing air to the helmet and electrical energy generated by the photovoltaic power source on the helmet to the trunk-worn blower.

In certain embodiments, the flexible air-electrical conductor comprises an air hose and a wire running along the air hose. In further embodiments, the wire is integral with the air hose. In still further embodiments, the air hose comprises a first coupling at a first end of the air hose and a second coupling at a second end of the air hose, and the wire interconnects the first coupling and the second coupling such that the electrical energy generated by the photovoltaic power source is conducted through the first coupling and the second coupling of the air hose. In certain embodiments, the fan is a radial fan configured to pressurize a blower enclosure, the flexible air-electrical conductor, and the helmet, and the photovoltaic power source is operably connected to supply electrical energy to one or both of the rechargeable battery and the radial fan. In certain embodiments, the photovoltaic power source is a first photovoltaic power source, the lens comprises an auto-darkening LCD cartridge and includes an additional battery and second photovoltaic power source for powering the auto-darkening LCD cartridge, and the first photovoltaic power source supplies electrical energy to both of the trunk-worn blower and the auto-darkening LCD cartridge. In certain embodiments, the helmet includes an indicator for indicating a status of the trunk-worn blower. In further embodiments, the indicator indicates at least one of: blower running, blower fan speed, battery voltage, and battery charge level, and wherein the lens comprises an auto-darkening LCD cartridge that includes the indicator.

In accordance with another aspect of the present invention, provided is a powered air-purifying respirator helmet system. The system comprises a helmet including a lens. A photovoltaic power source is mounted on the helmet. A trunk-worn blower is separate from the helmet. The trunk-worn blower comprises a fan and a rechargeable battery operably connected to power the fan. An air hose interconnects the trunk-worn blower and the helmet to supply pressurizing air to the helmet. A cable runs along the air hose and interconnects the trunk-worn blower and the helmet to supply electrical energy generated by the photovoltaic power source to the trunk-worn blower.

In certain embodiments, the cable is integral with the air hose. In certain embodiments, the air hose comprises a first coupling at a first end of the air hose and a second coupling at a second end of the air hose, and the cable interconnects the first coupling and the second coupling such that the electrical energy generated by the photovoltaic power source is conducted through the first coupling and the second coupling of the air hose. In certain embodiments, the fan is a radial fan configured to pressurize a blower enclosure, the air hose, and the helmet; and the photovoltaic power source is operably connected to supply electrical energy to one or both of the rechargeable battery and the radial fan. In certain embodiments, the photovoltaic power source is a first photovoltaic power source, the lens comprises an auto-darkening LCD cartridge and includes an additional battery and second photovoltaic power source for powering the auto-darkening LCD cartridge, and the first photovoltaic power source supplies electrical energy to both of the trunk-worn blower and the auto-darkening LCD cartridge. In certain embodiments, the helmet includes an indicator for indicating a status of the trunk-worn blower. In further embodiments, the indicator indicates at least one of: blower running, blower fan speed, battery voltage, and battery charge level, and wherein the lens comprises an auto-darkening LCD cartridge that includes the indicator.

In accordance with another aspect of the present invention, provided is a powered air-purifying respirator helmet system. The system comprises a helmet including a lens comprising an auto-darkening LCD cartridge. A photovoltaic power source is mounted on the helmet. A trunk-worn blower is separate from the helmet, the trunk-worn blower comprising a radial fan and a rechargeable battery operably connected to power the radial fan. An air hose interconnects the trunk-worn blower and the helmet to supply pressurizing air to the helmet. The photovoltaic power source supplies electrical energy to both of the trunk-worn blower and the auto-darkening LCD cartridge.

In certain embodiments, a cable runs along the air hose and interconnects the trunk-worn blower and the helmet to supply electrical energy generated by the photovoltaic power source to the trunk-worn blower. In further embodiments, the cable is integral with the air hose, and the air hose comprises a first coupling at a first end of the air hose and a second coupling at a second end of the air hose, and the cable interconnects the first coupling and the second coupling such that electrical energy generated by the photovoltaic power source is conducted through the first coupling and the second coupling in the air hose. In still further embodiments, the helmet includes an indicator for indicating a status of the trunk-worn blower, the indicator indicating at least one of: blower running, blower fan speed, battery voltage, and battery charge level.

### BRIEF DESCRIPTION OF THE DRAWINGS

FIG. 1 is a perspective view of a PAPR welding helmet system;

FIG. 2 is a perspective view of the PAPR welding helmet system in use;

FIG. 3 shows an example auto-darkening LCD cartridge for a welding helmet;

FIG. 4 is a perspective view of an air hose;

FIG. 5 is a perspective view of an air hose; and

FIG. 6 is a schematic electrical diagram of an example PAPR welding helmet system.

### DETAILED DESCRIPTION OF THE INVENTION

The present invention relates to powered air-purifying respirator (PAPR) welding helmets. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

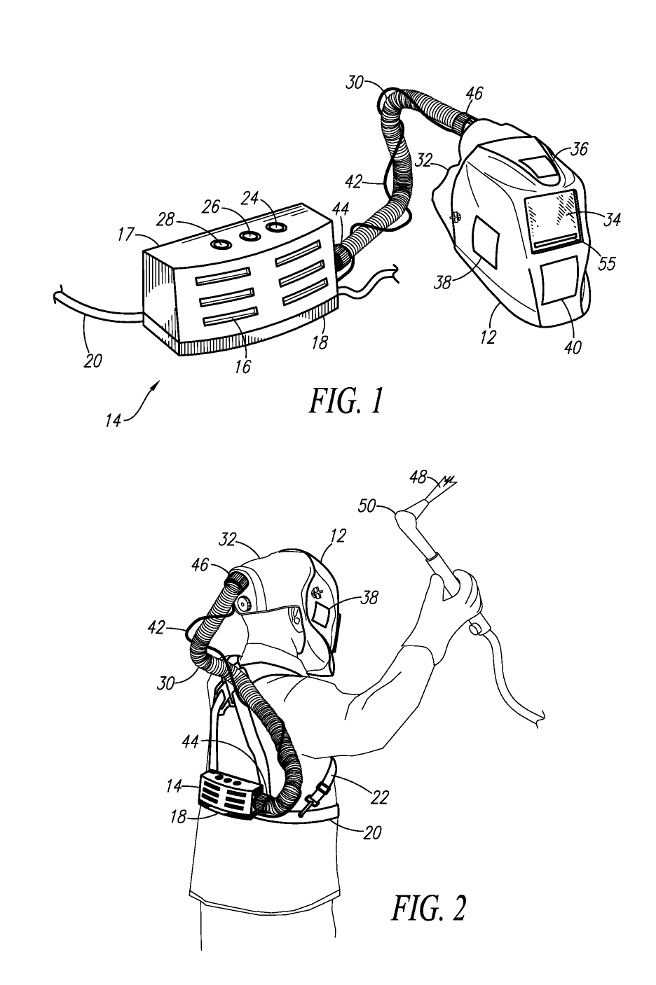

FIG. 1 provides a perspective view of an example PAPR welding helmet system. The system includes a helmet, such as a welding helmet 12, and a trunk-worn blower 14 (hereinafter “blower”). The welding helmet 12 and blower 14 are separate but interconnected devices that form parts of the PAPR system.

The blower 14 has a fan (not shown) for drawing air into the blower from the environment through a plurality of air intake ports 16. Example fans for use in the blower 14 in include radial and axial fans. A radial fan draws in air along its axis and discharges it radially due to a rotating impeller. An axial fan moves air along its axis of rotation due to rotating fan blades. The specific shape given to the blower housing or enclosure 17 can be based on the type of fan used in the blower 14. For example, an axial fan can allow the blower enclosure 17 to assume a narrow, rectangular shape (as shown in FIG. 1), since air is discharged radially from the fan. If an axial fan is used, the blower enclosure 17 can have a more elongated and possibly less narrow shape (e.g., cylindrical) to accommodate an axial air flow within the enclosure.

The blower 14 further includes one or more filters for filtering airborne matter from the environment. For example, the blower 14 can include a pre-filter (e.g., a foam filter) followed by a HEPA filter (high-efficiency particulate air filter).

The blower 14 and its fan are powered by a rechargeable battery 18. In certain embodiments, the battery 18 is readily removable for replacement with another battery and/or for recharging the battery remotely from the blower. An example battery is a sealed 12V lithium-ion battery.

The blower 14 is worn by a welding operator, as shown in FIG. 2. The blower 14 can be attached to a belt 20 and/or a shoulder harness 22 that is worn by the operator at least partially around the trunk of his body. Thus, the blower 14 is “trunk-worn”. The blower 14 can be worn at the back of the operator, to minimize the welding fumes drawn in by the blower 14.

The blower 14 can include operator controls 24, 26, 28 in the form of buttons, knobs, etc., to turn the blower on and off and to control the speed of the blower. For example, the blower 14 can be operated at either a low speed or a high speed, to thereby deliver different volumes of air to the helmet 12 per unit time (different CFM). The blower 14 can also include indicators, such as an ON/OFF indicator, a battery charge level indicator, and the like.

A flexible air hose 30 connects the blower 14 to the welding helmet 12 and supplies pressurizing air from the blower to pressurize the helmet. The helmet 12 can include a sealing hood 32 for establishing a pressurized environment around the face of the welding operator. The fan in the blower 14 pressurizes the blower enclosure 17, the air hose 30 interconnecting the blower enclosure and the welding helmet 12, the helmet, and sealing hood 32 with air drawn from the environment.

The welding helmet 12 includes lens 34 to protect the eyes of the welding operator during welding. The lens 34 can be a glass lens with a fixed shade, or the lens can be an electronic, auto-darkening LCD cartridge. Auto-darkening LCD cartridges have arc sensors that respond to the light given off by an electric arc during arc welding. The arc sensors control the operation of a liquid crystal display (LCD) lens in the cartridge. The LCD lens can quickly change from a light state in which a workpiece is readily visible to a dark state, based on the presence of an arc. When the LCD lens is in the dark state, the operator is protected from the light of the arc.

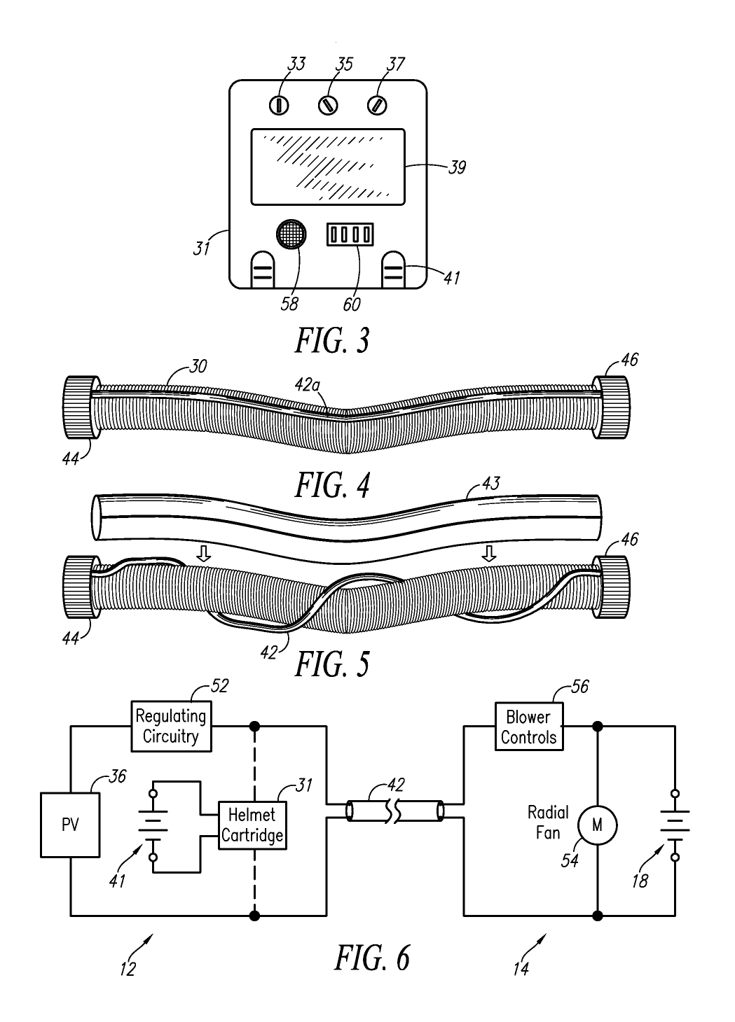

An example auto-darkening LCD cartridge 31 is shown in FIG. 3. The auto-darkening LCD cartridge 31 can include operator controls 33, 35, 37 to adjust parameters such as shade level, sensitivity, and delay. An operator might require a higher shade level when the electric arc used for welding is particularly bright, such as when welding thick materials at high amperages. A lower shade level might be desired when using a less intense arc, such as when welding thinner materials at lower amperages. The sensitivity setting determines the light level at which the LCD lens 39 switches from the light to the dark state. An operator can reduce the sensitivity setting to avoid nuisance switching of the lens state, such as while working in the presence of other welding operators. Delay controls can be used to lengthen or shorten the amount of time it takes for the lens to return to the light state following the completion of a weld. The auto-darkening LCD cartridge 31 can include one or more batteries 41 for powering the cartridge. The auto-darkening LCD cartridge 31 can include additional interface devices for communicating information about the status of the blower, such as a speaker 58 and/or visual indicator 60, as discussed further below.

Returning to FIGS. 1 and 2, the welding helmet 12 includes one or more photovoltaic (PV) power sources 36, 38, 40, such as PV cells (or arrays of PV cells), mounted on the helmet. The PV power sources 36, 38, 40 supply electrical power to the blower 14 to at least partially power the fan in the blower and/or charge the battery 18. The PV power sources 36, 38, 40 can help minimize the size of the battery 18 in the blower 14 and/or maximize the length of time that the battery can be used before recharging is required. Electrical energy generated by the PV power sources 36, 38, 40 is supplied to the blower 14 via an electrical conductor 42 (e.g., wires or a cable) running along the air hose 30.

During a welding operation, in particular an arc welding operation, the light generated during welding irradiates the PV power sources 36, 38, 40 on the welding helmet 12. The PV power sources 36, 38, 40 in turn generate electricity, which is used to power the blower 14 and/or charge the battery 18 in the blower. In FIG. 2, an electric arc 48 is generated from a welding torch 50, and the PV power sources on the welding helmet 12 convert light from the arc into electricity for powering the blower 14 and/or charging the battery 18.

The electrical conductor 42 runs along the air hose 30. Together, the air hose 30 and electrical conductor 42 form a flexible conductor for both air and electricity (i.e., a flexible air-electrical conductor) that interconnects the blower 14 and welding helmet 12. The flexible air-electrical conductor simultaneously supplies both pressurizing air to the helmet 12 and electrical energy generated by the PV power sources 36, 38, 40 to the blower 14.

In certain embodiments, the conductor 42 is integral with the air hose 30. FIG. 4 shows an example embodiment in which a cable 42a for supplying power to the blower has been embedded within the housing or wall of the air hose 30. The couplings 44, 46 at either end of the air hose 30 can provide electrical connections from the helmet 12 (FIGS. 1 and 2) and its PV power sources 36, 38, 40 to the blower 14. The cable 42a interconnects the couplings 44, 46 so that the electrical energy generated by the PV power sources on the welding helmet is conducted through the couplings to the blower. The couplings 44, 46 and the associated ports (outlets or inlets) on the blower and welding helmet can have terminals for transmitting the electrical energy generated by the PV power sources to the conductor 42a and blower through the couplings 44, 46. Thus, the couplings 44, 46 can be part of the power supply circuitry from the helmet 12 to the blower 14, and can conduct electrical energy from the PV power sources 36, 38, 40 to the blower via said terminals.

FIG. 5 shows another example embodiment in which the conductor 42 is integral with the air hose 30. The conductor 42 is wrapped around a wall or carcass of the hose 30, and the conductor 42 and wall or carcass are covered with a fabric sleeve 43. Again, the couplings 44, 46 at either end of the air hose can provide electrical connections from the helmet 12 (FIGS. 1 and 2) and its PV power sources 36, 38, 40 to the blower 14, with the conductor 42 interconnecting the couplings 44, 46.

Returning to FIGS. 1 and 2, the PV power sources can be located on the welding helmet 12 so as to maximize their exposure to the light from the arc 48. It is to be appreciated that any number of PV power sources can be placed on the welding helmet 12 as desired. For example, the surface of the welding helmet could be substantially covered by PV power sources. Additional PV power sources for powering the blower can be incorporated into the belt 20 and/or shoulder harness 22, or into protective clothing worn by the welding operator (e.g., into a welding jacket).

A schematic electrical diagram of a PAPR welding helmet system is shown in FIG. 6. One or more PV power sources (shown schematically as PV power source 36) at the welding helmet 12 supplies electrical energy to the battery 18 and/or radial fan 54 at the blower 14. The conductor 42 electrically connects the welding helmet 12 to the blower 14 as described above. The welding helmet 12 can include regulating circuitry 52 for regulating the voltage/current/power supplied to the blower 14 from the PV power source 36. Alternatively, the regulating circuitry can be incorporated into blower control circuitry 56 at the blower 14.

In certain embodiments, the PV power sources can supply power to the auto-darkening LCD cartridge 31 in addition to the blower 14, as shown schematically in FIG. 6. Auto-darkening LCD cartridges require a source of power to operate, and the power supply for the cartridge can be integrated with the power supply for the blower. The PV power source 36 on the welding helmet can provide power to the auto-darkening LCD cartridge 31 and/or to the battery 41 for the cartridge and simultaneously provide power to the blower 14. As shown in FIG. 1, the cartridge itself can include a PV power source 55 for supplying electrical energy to the cartridge and/or the blower 14.

In certain embodiments, information is transmitted from the blower 14 to the welding helmet 12 and conveyed to the welding operator by the welding helmet. For example, information can be transmitted from the blower 14 to the welding helmet 12 via the conductor 42 (FIGS. 1, 2). The information could also be transmitted wirelessly via short-range wireless communications (e.g., Bluetooth). Transmitted information can include blower status, such as blower running (e.g., ON/OFF), blower fan speed, battery voltage, battery charge level, estimated remaining run time, filter status (e.g., blocked or clogged condition), average power from PV power sources, etc. The information can be conveyed to the welding operator audibly and/or visually by the welding helmet 12. For example, the welding helmet can emit audible beeps to convey information to the welding operator. In FIG. 3, the auto-darkening LCD cartridge 31 includes a speaker 58 for providing an audible indication or alarm (e.g., for low blower battery charge) and a visual indicator 60 (e.g., for blower battery charge).

In an embodiment, the PAPR welding helmet system with PV power sources is capable of operating the blower 14 for at least eight hours.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A powered air-purifying respirator helmet system, comprising:
a helmet including a lens;
a photovoltaic power source mounted on the helmet;
a trunk-worn blower separate from the helmet, the trunk-worn blower comprising a fan and a rechargeable battery operably connected to power the fan;
a flexible air-electrical conductor interconnecting the trunk-worn blower and the helmet to simultaneously supply both pressurizing air to the helmet and electrical energy generated by the photovoltaic power source on the helmet to the trunk-worn blower.

2. The powered air-purifying respirator helmet system of claim 1, wherein the flexible air-electrical conductor comprises an air hose and a wire running along the air hose.

3. The powered air-purifying respirator helmet system of claim 2, wherein the wire is integral with the air hose.

4. The powered air-purifying respirator helmet system of claim 2, wherein the air hose comprises a first coupling at a first end of the air hose and a second coupling at a second end of the air hose, and wherein the wire interconnects the first coupling and the second coupling such that the electrical energy generated by the photovoltaic power source is conducted through the first coupling and the second coupling.

5. The powered air-purifying respirator helmet system of claim 1, wherein the fan is a radial fan configured to pressurize a blower enclosure, the flexible air-electrical conductor, and the helmet, and
wherein the photovoltaic power source is operably connected to supply electrical energy to one or both of the rechargeable battery and the radial fan.

6. The powered air-purifying respirator helmet system of claim 1, wherein the photovoltaic power source is a first photovoltaic power source;
wherein the lens comprises an auto-darkening LCD cartridge and includes an additional battery and second photovoltaic power source for powering the auto-darkening LCD cartridge, and
wherein the first photovoltaic power source supplies electrical energy to both of the trunk-worn blower and the auto-darkening LCD cartridge.

7. The powered air-purifying respirator helmet system of claim 1, wherein the helmet includes an indicator for indicating a status of the trunk-worn blower.

8. The powered air-purifying respirator helmet system of claim 7, wherein the indicator indicates at least one of: blower ON/OFF, blower fan speed, battery voltage, and battery charge level, and wherein the lens comprises an auto-darkening LCD cartridge that includes the indicator.

9. A powered air-purifying respirator helmet system, comprising:
a helmet including a lens;
a photovoltaic power source mounted on the helmet;
a trunk-worn blower separate from the helmet, the trunk-worn blower comprising a fan and a rechargeable battery operably connected to power the fan;
an air hose interconnecting the trunk-worn blower and the helmet to supply pressurizing air to the helmet;
and a cable running along the air hose and interconnecting the trunk-worn blower and the helmet to supply electrical energy generated by the photovoltaic power source to the trunk-worn blower.

10. The powered air-purifying respirator helmet system of claim 9, wherein the cable is integral with the air hose.

11. The powered air-purifying respirator helmet system of claim 9, wherein air hose comprises a first coupling at a first end of the air hose and a second coupling at a second end of the air hose, and wherein the cable interconnects the first coupling and the second coupling such that the electrical energy generated by the photovoltaic power source is conducted through the first coupling and the second coupling.

12. The powered air-purifying respirator helmet system of claim 9, wherein the fan is a radial fan configured to pressurize a blower enclosure, the air hose, and the helmet, and
wherein the photovoltaic power source is operably connected to supply electrical energy to one or both of the rechargeable battery and the radial fan.

13. The powered air-purifying respirator helmet system of claim 9, wherein the photovoltaic power source is a first photovoltaic power source;
wherein the lens comprises an auto-darkening LCD cartridge and includes an additional battery and second photovoltaic power source for powering the auto-darkening LCD cartridge, and
wherein the first photovoltaic power source supplies electrical energy to both of the trunk-worn blower and the auto-darkening LCD cartridge.

14. The powered air-purifying respirator helmet system of claim 9, wherein the helmet includes an indicator for indicating a status of the trunk-worn blower.

15. The powered air-purifying respirator helmet system of claim 14, wherein the indicator indicates at least one of: blower ON/OFF, blower fan speed, battery voltage, and battery charge level, and wherein the lens comprises an auto-darkening LCD cartridge that includes the indicator.

16. A powered air-purifying respirator helmet system, comprising:
a helmet including a lens comprising an auto-darkening LCD cartridge;
a photovoltaic power source mounted on the helmet;
a trunk-worn blower separate from the helmet, the trunk-worn blower comprising a radial fan and a rechargeable battery operably connected to power the radial fan;
an air hose interconnecting the trunk-worn blower and the helmet to supply pressurizing air to the helmet,
wherein the photovoltaic power source supplies electrical energy to both of the trunk-worn blower and the auto-darkening LCD cartridge.

17. The powered air-purifying respirator helmet system of claim 16, further comprising a cable running along the air hose and interconnecting the trunk-worn blower and the helmet to supply electrical energy generated by the photovoltaic power source to the trunk-worn blower.

18. The powered air-purifying respirator helmet system of claim 17, wherein the cable is integral with the air hose,
wherein air hose comprises a first coupling at a first end of the air hose and a second coupling at a second end of the air hose, and
wherein the cable interconnects the first coupling and the second coupling such that electrical energy generated by the photovoltaic power source is conducted through the first coupling and the second coupling.

19. The powered air-purifying respirator helmet system of claim 17, wherein the helmet includes an indicator for indicating a status of the trunk-worn blower, the indicator indicating at least one of: blower ON/OFF, blower fan speed, battery voltage, and battery charge level.
